(19) United States
(12) Patent Application Publication
(10) Pub. No.: US 2026/0185960 A1
(43) Pub. Date: Jul. 2, 2026

(54) DETECTION DEVICE AND DETECTION METHOD FOR DETECTION DEVICE

(71) Applicant: InnoLux Corporation, Miao-Li County (TW)

(72) Inventors: Kuang-Pin CHAO, Miao-Li County (TW); Min-Han TSAI, Miao-Li County (TW); Hao-Jung HUANG, Miao-Li County (TW); Cheng-Hsu CHOU, Miao-Li County (TW)

(21) Appl. No.: 19/410,193

(22) Filed: Dec. 5, 2025

Related U.S. Application Data
(60) Provisional application No. 63/741,204, filed on Jan. 2, 2025.

(30) Foreign Application Priority Data
Sep. 3, 2025 (CN) 202511251714.4

(51) Int. Cl. G01N 27/416; G01N 1/14; G01N 1/24

(52) U.S. Cl. CPC G01N 27/416; G01N 1/14; G01N 1/24

(57) ABSTRACT

A detection device includes a detection module, a delivery module and a control module. The delivery module includes a delivery pipeline assembly, a gas pump assembly connected to the detection module via the delivery pipeline assembly, and a liquid pump assembly connected to the detection module via the delivery pipeline assembly. The control module is electrically connected to the delivery module for controlling the gas pump assembly and the liquid pump assembly.

### CROSS-REFERENCE TO RELATED APPLICATIONS

This application claims the benefit of filing date of U.S. Provisional Application Ser. No. 63/741,204 filed on Jan. 2, 2025 under 35 USC § 119(e)(1), and also claims the benefit of the Chinese Patent Application Serial Number 202511251714.4, filed on Sep. 3, 2025, the subject matters of which are incorporated herein by reference.

### BACKGROUND

### Field of the Disclosure

The present disclosure relates to a detection device and a detection method for the detection device and, more particularly, to a detection device including a gas pump assembly and a detection method for the detection device.

### Description of Related Art

In the past, industrial liquid pH detection was performed mainly based on glass electrodes, which has a wide pH detection range and good operational stability. However, due to disadvantages such as high price and difficulty in electrode storage, the development of such detection has been hindered.

On the other hand, solution sensing chips have made rapid progress in research and development in recent years due to their advantages such as low cost and easy storage. However, the solution sensing chips still have disadvantages that limit their application.

Therefore, there is an urgent need to develop a detection device and a detection method in order to alleviate and/or obviate the aforementioned defects.

### SUMMARY

The present disclosure provides a detection device, which includes: a detection module; a delivery module including: a delivery pipeline assembly; a gas pump assembly connected to the detection module via the delivery pipeline assembly; and a liquid pump assembly connected to the detection module via the delivery pipeline assembly; and a control module electrically connected to the delivery module for controlling the gas pump assembly and the liquid pump assembly.

The present disclosure further provides a detection method for a detection device including a detection module, a control module, and a delivery module connected to the detection module. The detection method includes the steps of: delivering a liquid under test to the detection module through the delivery module; detecting the liquid under test with the detection module; delivering a cleaning liquid to the detection module through the delivery module; performing a first cleaning on the detection module with the cleaning liquid; and delivering a gas to the detection module through the delivery module, so that the gas dries the detection module.

Other novel features of the disclosure will become more apparent from the following detailed description when taken in conjunction with the accompanying drawings.

### BRIEF DESCRIPTION OF DRAWINGS

FIG. 1 is a schematic diagram of a detection device according to an embodiment of the present disclosure;

FIG. 2 is a schematic diagram of a detection device according to an embodiment of the present disclosure;

FIG. 3 is a schematic diagram of a detection module according to an embodiment of the present disclosure;

FIG. 4 is a schematic diagram of a detection module according to an embodiment of the present disclosure;

FIG. 5 is a schematic diagram of a detection module according to an embodiment of the present disclosure;

FIG. 6 is a schematic diagram of a detection module according to an embodiment of the present disclosure;

FIG. 7 is a schematic diagram of a detection module according to an embodiment of the present disclosure;

FIG. 8 is a flowchart of a detection method according to an embodiment of the present disclosure;

FIG. 9 is a flowchart of a calibration procedure according to an embodiment of the present disclosure; and

FIG. 10 is a flowchart of a pre-processing procedure according to an embodiment of the present disclosure.

### DETAILED DESCRIPTION OF EMBODIMENT

Directional terms mentioned in the specification, such as “up”, “down”, “front”, “rear”, “left”, “right”, etc., only refer to the directions of the drawings. Accordingly, the directional term used is illustrative, not limiting, of the present disclosure.

One structure described in the present disclosure is disposed on/above another structure, which may mean that the two structures are adjacent and directly connected, or may refer to two structures that are adjacent rather than directly connected. Indirect connection means that there is at least one intermediate structure between the two structures. The intermediate structure may be composed of a single layer or multiple layers of physical structures or non-physical structures, but not limited thereto. In the present disclosure, when a structure is disposed “on” another structure, it may mean that the structure is “directly” or “indirectly” on the other structure.

In some embodiments of the present disclosure, terms such as “connection” and “interconnection” about joining and connecting, unless otherwise specified, may mean that two structures are in direct contact, or may also mean that two structures are not in direct contact, where other structures are placed between the two structures. Moreover, the terms about joining and connecting may also include the situation that both structures are movable, or both structures are fixed. In addition, the term “couple” includes any direct and indirect means of electrical connection.

In the description, the terms “almost”, “about”, “approximately” or “substantially” usually means within 10%, 5%, 3%, 2%, 1% or 0.5% of a given value or range. Unless otherwise defined, the term “range between the first value and the second value” indicates that the range includes the first value, the second value, and other values in between. Moreover, any two values or directions used for comparison may have certain errors. If the first value is equal to the second value, it implies that there may be an error of about 10% between the first value and the second value; if the first direction is perpendicular or “approximately” perpendicular to the second direction, the angle between the first direction and the second direction may be between 80 degrees and 100 degrees; if the first direction is parallel or “substantially” parallel to the second direction, the angle between the first direction and the second direction may be between 0 degrees and 10 degrees. In the present disclosure, the expressions “the given range is from the first value to the second value” and “the given range falls within the range from the first value to the second value” indicate that the given range includes the first value, the second value, and other values in between.

Furthermore, according to the embodiments of the present disclosure, an optical microscope (OM), a scanning electron microscope (SEM), a film thickness profilometer (α-step), an ellipsometer thickness gauge, or other suitable means may be used to measure the depth, thickness, width or height of each component, or the spacing or distance between components. In details, according to some embodiments, a scanning electron microscope may be used to obtain a cross-sectional structure image including the components to be measured, and measure the depth, thickness, width or height of each component, or the spacing or distance between components.

It is noted that the following are exemplary embodiments of the present disclosure, but the present disclosure is not limited thereto, while a feature of some embodiments can be applied to other embodiments through suitable modification, substitution, combination, or separation. In addition, the present disclosure can be combined with other known structures to form further embodiments.

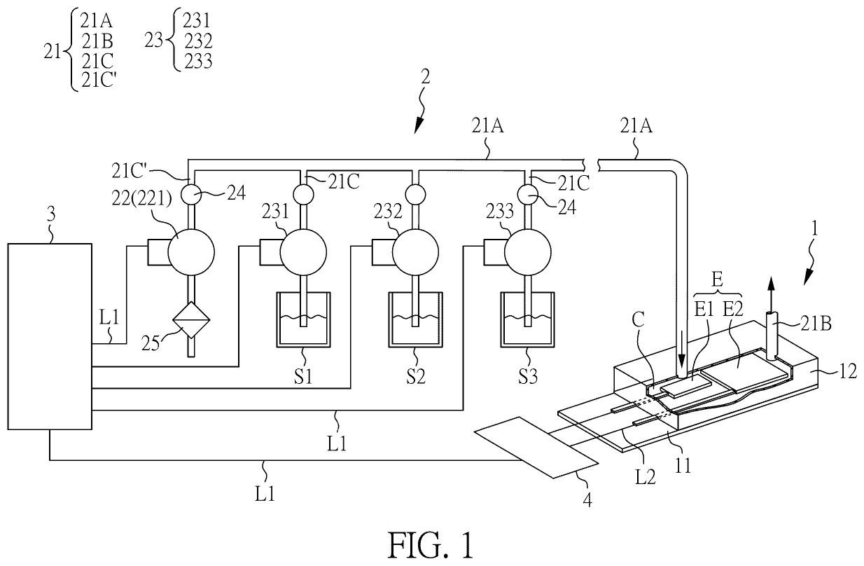

In one embodiment of the present disclosure, as shown in FIG. 1, a detection device may include: a detection module 1; a delivery module 2 including: a delivery pipeline assembly 21; a gas pump assembly 22 connected to the detection module 1 through the delivery pipeline assembly 21; and a liquid pump assembly 23 connected to the detection module 1 through the delivery pipeline assembly 21; and a control module 3 electrically connected to the delivery module 2 for controlling the gas pump assembly 22 and the liquid pump assembly 23. The detection device of the present disclosure may control the delivery module 2 via the control module 3 to supply a solution to the detection module 1 for performing detection, thereby achieving automated operation. More specifically, the liquid pump assembly 23 in the delivery module 2 may supply a solution to the detection module 1 via the delivery pipeline assembly 21 for detecting and/or processing, while the gas pump assembly 22 in the delivery module 2 may provide a gas to dry out any solution remaining in the delivery pipeline assembly 21, thereby facilitating the next operation. Through the aforementioned design, it is able to improve the detection accuracy of the detection device.

In the present disclosure, as shown in FIG. 1, the detection module 1 may include a cavity C and a detection electrode E disposed in the cavity C. The cavity C may be formed by a substrate 11 and a cover 12. The detection electrode E may, for example, include a first electrode E1 and a second electrode E2 disposed on the substrate 11 and disposed within the cavity C. A solution may be provided to the cavity C of the detection module 1 via the delivery module 2. By using the solution between the first electrode E1 and the second electrode E2 to act as a loop, it is able to perform solution detection.

In the present disclosure, the shape of the cavity C is not particularly limited. For example, in a top view, the cavity C may be circular, elliptical, rectangular, prismatic, hexagonal, octagonal, or other irregular shapes, but the present disclosure is not limited thereto. In the present disclosure, the material of the substrate 11 may include quartz, glass, silicon wafer, sapphire, plastic or polymer materials, other inorganic materials, other organic materials, or a combination thereof, but the present disclosure is not limited thereto. In the present disclosure, the material of the cover 12 may include quartz, glass, plastic or polymer materials, other inorganic materials, other organic materials, or a combination thereof, but the present disclosure is not limited thereto.

In the present disclosure, the sizes of the first electrode E1 and the second electrode E2 are not particularly limited. For example, in a top view, the projected area of the first electrode E1 on the substrate 11 may be greater than, equal to, or smaller than the projected area of the second electrode E2 on the substrate 11. In one embodiment of the present disclosure, as shown in FIG. 1, in a top view, the projected area of the first electrode E1 on the substrate 11 may be smaller than the projected area of the second electrode E2 on the substrate 11, but the present disclosure is not limited thereto. In the present disclosure, the shapes of the first electrode E1 and the second electrode E2 are not particularly limited. For example, the first electrode E1 and the second electrode E2 may each be circular, elliptical, rectangular, prismatic, hexagonal, octagonal, or other irregular shapes, but the present disclosure is not limited thereto. In one embodiment of the present disclosure, as shown in FIG. 1, the first electrode E1 and the second electrode E2 may each be rectangular, for example. In one embodiment of the present disclosure, the first electrode E1 may be, for example, a reference electrode, and the second electrode E2 may be, for example, a working electrode. However, the present disclosure is not limited thereto. In other embodiments, the first electrode E1 may be a working electrode, and the second electrode E2 may be a reference electrode. The reference electrode may include silver chloride or a silver chloride electrode including a (semi-)solid chloride compound structure (for example, KCl, NaCl, etc.). The working electrode may include a metal material, a sensing material, and a surface modification material. Suitable metal materials may include, for example, gold, silver, platinum, copper, aluminum, titanium, chromium, nickel, molybdenum, or a combination thereof, but the present disclosure is not limited thereto. Suitable sensing materials may include, for example, metal oxides, such as indium tin oxide (ITO), zinc dioxide, tin dioxide, indium zinc oxide (IZO), titanium nitride (TiN), titanium oxide (TiO), indium tin zinc oxide (ITZO), indium gallium zinc oxide (IGZO), aluminum zinc oxide (AZO), ruthenium oxide (RuO2, RuO4), or a combination thereof, but the present disclosure is not limited thereto. Surface modification materials may include, for example, Nafion, biotin, and polyaniline (PANI), but the present disclosure is not limited thereto. In one embodiment of the present disclosure, the detection device may be, for example, a pH detection device for detecting the pH value of a liquid under test. When the working electrode is affected by the pH values of different liquids under test, indicating that the solutions have different hydrogen ion concentrations, the working electrode may exhibit different induced voltage changes, thereby detecting the pH values of different liquids under test. In one embodiment of the present disclosure, the surface of the working electrode may be modified in various ways as needed to enable the working electrode to be used for other detection applications. For example, the surface of the working electrode may be modified with gold nanoparticles, so that the working electrode may serve as a glucose sensing electrode, allowing the detection device to be used for glucose detection, but the present disclosure is not limited thereto. In one embodiment of the present disclosure, the working electrode may be electrochemically combined with electrode material adjustment and surface modification to measure the pH value, redox potential, sodium ion concentration, potassium ion concentration, electrochemical biochemical detection (for example, lactate, creatinine, proteinuria, etc.), or physical properties detection (for example, temperature, conductivity, etc.) through designed electrodes or components, or other detections, but the present disclosure is not limited thereto this. In one embodiment of the present disclosure, the detection electrode E may include a first electrode E1, a second electrode E2 and one or more other electrodes (not shown), which are disposed on the substrate 11 and located in the cavity C, so that the detection device may be used for various detections, but the present disclosure is not limited thereto.

In one embodiment of the present disclosure, as shown in FIG. 1, the delivery pipeline assembly 21 may selectively include an inlet pipeline 21A, an outlet pipeline 21B and a connecting pipeline (including 21C and 21C′). The inlet pipeline 21A may be connected to the cavity C of the detection module 1, so that the solution may flow into the cavity C through the inlet pipeline 21A. The outlet pipeline 21B may be connected to the cavity C of the detection module 1, so that the solution may be discharged from the cavity C through the outlet pipeline 21B. One end of the connecting pipeline 21C may be connected to the inlet pipeline 21A, and the other end thereof may be connected to the liquid pump assembly 23, so that the solution may be provided to the cavity C through the connecting pipeline 21C and the inlet pipeline 21A. One end of the connecting pipeline 21C′ may be connected to the inlet pipeline 21A, and the other end thereof may be connected to the gas pump assembly 22, so that gas may be provided to the cavity C through the connecting pipeline 21C′ and the inlet pipeline 21A. In the present disclosure, the number of inlet pipelines 21A and outlet pipelines 21B may be adjusted as needed, and the number of connecting pipelines 21C and 21C′ may depend on the number of liquid pump assemblies 23 and gas pump assemblies 22.

In the present disclosure, the inlet pipeline 21A, the outlet pipeline 21B, the connecting pipeline 21C, and the connecting pipeline 21C′ are channels that allow solutions and gases to pass through. The materials of the inlet pipeline 21A, the outlet pipeline 21B, the connecting pipeline 21C, and the connecting pipeline 21C′ may each include quartz, glass, plastic or polymer materials, other inorganic materials or other organic materials, or a combination thereof, but the present disclosure is not limited thereto.

In the present disclosure, the gas pump assembly 22 may have a first number of gas pumps, and the liquid pump assembly 23 may have a second number of liquid pumps, wherein the second number is greater than the first number. For example, in one embodiment of the present disclosure, as shown in FIG. 1, the gas pump assembly 22 may have one gas pump 221, and the liquid pump assembly 23 may have three liquid pumps (for example, including liquid pumps 231, 232 and 233), but the present disclosure is not limited thereto. In other embodiments, the number of gas pumps and liquid pumps may be adjusted as needed. The gas pump 221 may be used to provide and deliver a gas to the detection module 1 via the delivery pipeline assembly 21 so as to dry the solution remaining in the delivery pipeline assembly 21, or the cavity C of the detection module 1 may be placed in a specific gas atmosphere (for example, an inert gas, nitrogen, etc.), thereby reducing the impact on the detection electrode E that is sensitive to air or oxygen. The liquid pumps (including the liquid pumps 231, 232 and 233) may be used to provide and deliver a solution to the detection module 1 via the delivery pipeline assembly 21 so as to perform detection of the solution.

In one embodiment of the present disclosure, as shown in FIG. 1, the connection between the liquid pump assembly 23 and the delivery pipeline assembly 21 is located between the connection between the gas pump assembly 22 and the delivery pipeline assembly 21 and the connection between the detection module 1 and the delivery pipeline assembly 21. More specifically, the liquid pump (for example, liquid pumps 231, 232, and/or 233) may be connected to the inlet pipeline 21A via the connecting pipeline 21C, the gas pump 221 may be connected to the inlet pipeline 21A via the connecting pipeline 21C', and the cavity C of the detection module 1 may be connected to the inlet pipeline 21A. The connection between the connecting pipeline 21C and the inlet pipeline 21A may be located between the connection between the connecting pipeline 21C′ and the inlet pipeline 21A and the connection between the cavity C and the inlet pipeline 21A. However, the present disclosure is not limited thereto. In other embodiments, the connection relationship of the above components may be adjusted as needed.

In one embodiment of the present disclosure, as shown in FIG. 1, the delivery module 2 may further selectively include one or more check valves 24 disposed between the inlet pipeline 21A and the gas pump assembly 22 and/or the liquid pump assembly 23; and one or more filters 25 connected to the gas pump assembly 22. The check valve 24 is used to prevent the backflow of liquid or gas, thereby reducing contamination and improving the reliability of the detection device. The filter 25 is used to filter the gas provided to the gas pump assembly 22, thereby increasing the purity of the required gas and alleviating the effect of impurities in the gas on the detection.

In one embodiment of the present disclosure, as shown in FIG. 1, the control module 3 may be electrically connected to the gas pump assembly 22 and the liquid pump assembly 23 via a signal line L1 to automatically control the operation of the gas pump 221 and the liquid pumps (including the liquid pumps 231, 232 and 233).

In one embodiment of the present disclosure, as shown in FIG. 1, the detection device may further include a signal measurement module 4 electrically connected to the detection electrode E of the detection module 1. More specifically, the signal measurement module 4 may be electrically connected to the first electrode E1 and the second electrode E2 via a wire L2 to provide and/or receive signals from the first electrode E1 and the second electrode E2, thereby obtaining a detection result. In one embodiment of the present disclosure, as shown in FIG. 1, the signal measurement module 4 may be electrically connected to the control module 3 via a signal line L1 to control the signals (for example, voltage) applied to and received from the first electrode E1 and the second electrode E2. When the detection module 1 performs a measurement, a signal analysis module (not shown) and a relay may be used to perform the measurement in conjunction with the desired measurement item of the object under test, or the measurement may be performed by multiple signal analysis modules, but the present disclosure is not limited thereto. In one embodiment of the present disclosure, the signal measurement module 4 receives the sensing signals from the first electrode E1 and the second electrode E2 and, after analysis, may selectively output the data through a wired or wireless module, but the present disclosure is not limited thereto.

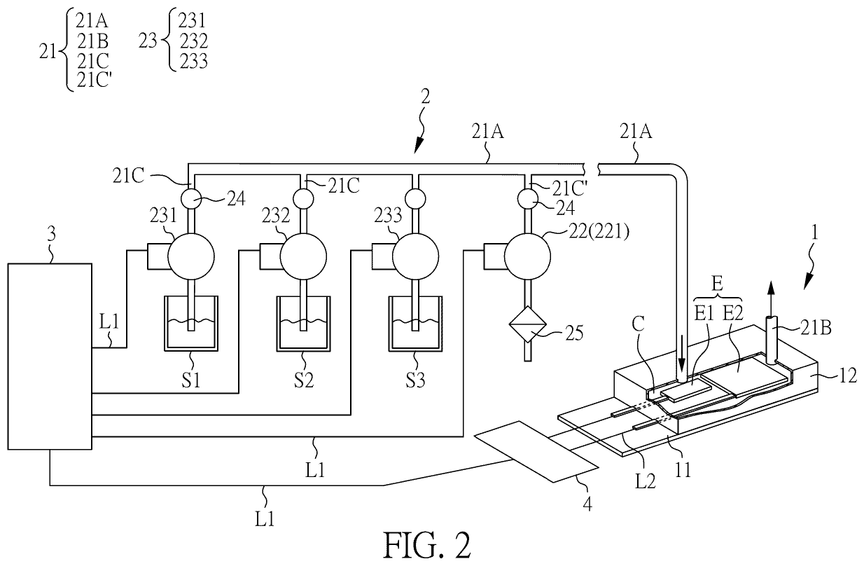

In one embodiment of the present disclosure, as shown in FIG. 2, the connection between the gas pump assembly 22 and the delivery pipeline assembly 21 is located between the connection between the liquid pump assembly 23 and the delivery pipeline assembly 21 and the connection between the detection module 1 and the delivery pipeline assembly 21. More specifically, the gas pump 221 may be connected to the inlet pipeline 21A via the connecting pipeline 21C′, the liquid pump (for example, the liquid pump 231, 232 and/or 233) may be connected to the inlet pipeline 21A via the connecting pipeline 21C, and the cavity C of the detection module 1 may be connected to the inlet pipeline 21A. The connection between the connecting pipeline 21C′ and the inlet pipeline 21A may be located between the connection between the connecting pipeline 21C and the inlet pipeline 21A and the connection between the cavity C and the inlet pipeline 21A. However, the present disclosure is not limited thereto. In other embodiments, the connection relationship of the above components may be adjusted as needed.

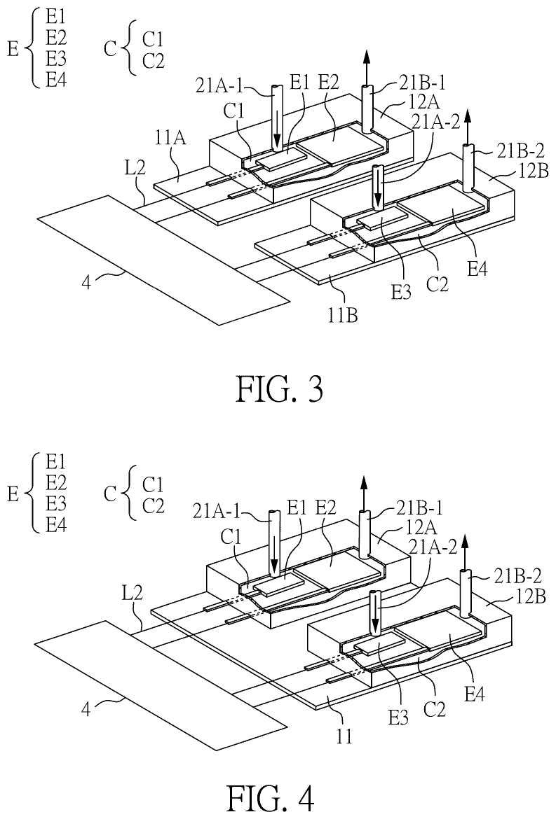

In one embodiment of the present disclosure, as shown in FIG. 3, the cavity C of the detection module 1 may include a first cavity C1 and a second cavity C2, and the detection electrode E may include a first electrode E1, a second electrode E2, a third electrode E3 and a fourth electrode E4, wherein the first electrode E1 and the second electrode E2 are disposed in the first cavity C1, and the third electrode E3 and the fourth electrode E4 are disposed in the second cavity C2. The delivery module 2 (as shown in FIG. 1 and FIG. 2) may provide a solution to the first cavity C1 and the second cavity C2, respectively. The solution may be detected by forming a loop between the first electrode E1 and the second electrode E2, and between the third electrode E3 and the fourth electrode E4. More specifically, the delivery pipeline assembly 21 of the delivery module 2 (as shown in FIG. 1 and FIG. 2) may include inlet pipelines 21A-1 and 21A-2, and outlet pipelines 21B-1 and 21B-2. One end of the inlet pipeline 21A-1 is connected to the first cavity C1, and the other end thereof is connected to the gas pump assembly 22 (as shown in FIG. 1 and FIG. 2) and the liquid pump assembly 23 (as shown in FIG. 1 and FIG. 2). A solution may be provided to the first cavity C1 for detection and/or processing through the inlet pipeline 21A-1, and the solution may be discharged from the first cavity C1 through the outlet pipeline 21B-1. One end of the inlet pipeline 21A-2 is connected to the second cavity C2, and the other end thereof is connected to the gas pump assembly 22 (as shown in FIG. 1 and FIG. 2) and the liquid pump assembly 23 (as shown in FIG. 1 and FIG. 2). Another solution may be provided to the second cavity C2 for detection and/or processing through the inlet pipeline 21A-2, and another solution may be discharged from the second cavity C2 through the outlet pipeline 21B-2. In the present disclosure, the solution and the other solutions may be the same or different and may be adjusted according to detection needs.

In the present disclosure, the shapes of the first cavity C1 and the second cavity C2 may be the same or different and, in a top view, the shapes of the first cavity C1 and the second cavity C2 may each be circular, elliptical, rectangular, prismatic, hexagonal, octagonal, or other irregular shapes, but the present disclosure is not limited thereto. In one embodiment of the present disclosure, the first cavity C1 may be formed by the first substrate 11A and the first cover 12A, and the second cavity C2 may be formed by the second substrate 11B and the second cover 12B. Therefore, the first electrode E1 and the second electrode E2 may be disposed on the first substrate 11A, and the third electrode E3 and the fourth electrode E4 may be disposed on the second substrate 11B, but the present disclosure is not limited thereto. In the present disclosure, the materials of the first substrate 11A and the second substrate 11B may be the same or different, and the materials of the first substrate 11A and the second substrate 11B may each be as described for the substrate 11 (as shown in FIG. 1), and thus a detailed description is deemed unnecessary. In the present disclosure, the materials of the first cover 12A and the second cover 12B may be the same or different, and the materials of the first cover 12A and the second cover 12B each may be as those described for the cover 12 (as shown in FIG. 1), and thus a detailed description is deemed unnecessary.

In the present disclosure, the inlet pipelines 21A-1 and 21A-2 and the outlet pipelines 21B-1 and 21B-2 are channels that allow solutions and gases to pass through. The materials of the inlet pipelines 21A-1 and 21A-2 and the outlet pipelines 21B-1 and 21B-2 may each include quartz, glass, plastic or polymer materials, other inorganic materials or other organic materials, or a combination thereof, but the present disclosure is not limited thereto.

In the present disclosure, the features of the first electrode E1 and the second electrode E2 may be as described above and will not be repeated here. In the present disclosure, the sizes of the third electrode E3 and the fourth electrode E4 are not particularly limited. For example, in a top view, the projected area of the third electrode E3 on the second substrate 11B may be greater than, equal to, or smaller than the projected area of the fourth electrode E4 on the second substrate 11B. In one embodiment of the present disclosure, as shown in FIG. 3, the projected area of the third electrode E3 on the second substrate 11B may be smaller than the projected area of the fourth electrode E4 on the second substrate 11B, but the present disclosure is not limited thereto. In the present disclosure, the shapes of the third electrode E3 and the fourth electrode E4 are not particularly limited. For example, the third electrode E3 and the fourth electrode E4 may each be circular, elliptical, rectangular, prismatic, hexagonal, octagonal, or other irregular shapes, but the present disclosure is not limited thereto. In one embodiment of the present disclosure, as shown in FIG. 3, the third electrode E3 and the fourth electrode E4 may be rectangular, for example. In one embodiment of the present disclosure, the third electrode E3 may be, for example, a reference electrode, and the fourth electrode E4 may be, for example, a working electrode, but the present disclosure is not limited thereto. In other embodiments, the third electrode E3 may be a working electrode, and the fourth electrode E4 may be a reference electrode.

In the present disclosure, the first electrode E1 may be the same as or different from the third electrode E3, and the second electrode E2 may be the same as or different from the fourth electrode E4. In one embodiment of the present disclosure, when the first electrode E1 and the third electrode E3 serve as reference electrodes, the second electrode E2 and the fourth electrode E4 serve as the same working electrodes, and the solution flowing into the first cavity C1 and the solution flowing into the second cavity C2 are the same, so that the detection device may perform repeated detection (multiple detections) on the same solution, thereby shortening the measurement interval or improving measurement accuracy by comparing data. In one embodiment of the present disclosure, when the first electrode E1 and the third electrode E3 serve as reference electrodes, the second electrode E2 and the fourth electrode E4 serve as the same working electrodes, and the solution flowing into the first cavity C1 and the solution flowing into the second cavity C2 are different, the detection device may perform the same detection on different solutions, thereby saving detection time. In one embodiment of the present disclosure, when the first electrode E1 and the third electrode E3 serve as reference electrodes, the solution flowing into the first cavity C1 is the same as the solution flowing into the second cavity C2, and the second electrode E2 and the fourth electrode E4 are different working electrodes, the detection device may detect different parameters of the same solution, thereby saving detection time. In one embodiment of the present disclosure, when the first electrode E1 and the third electrode E3 serve as reference electrodes, the second electrode E2 and the fourth electrode E4 are different working electrodes, and the solution flowing into the first cavity C1 is also different from the solution flowing into the second cavity C2, the detection device may detect different parameters of different solutions, thereby saving detection time. In one embodiment of the present disclosure, when the first electrode E1 and the third electrode E3 are reference electrodes, and the second electrode E2 and the fourth electrode E4 are the same working electrodes, the detection device may achieve a longer replacement cycle for the detection module 1 through cross-measurement. For example, after providing a solution to the first cavity C1 for measurement, the solution may be provided to the second cavity C2 for measurement at an interval, and the interval may be adjusted as needed.

In one embodiment of the present disclosure, as shown in FIG. 3, the signal measurement module 4 may be electrically connected to the first electrode E1, the second electrode E2, the third electrode E3 and the fourth electrode E4 through the wire L2 to provide and/or receive signals from the first electrode E1, the second electrode E2, the third electrode E3 and the fourth electrode E4, thereby obtaining a detection result.

In one embodiment of the present disclosure, as shown in FIG. 4, the first cavity C1 may be formed by the substrate 11 and the first cover 12A, and the second cavity C2 may be formed by the substrate 11 and the second cover 12B. The first electrode E1 and the second electrode E2 may be disposed on the substrate 11 and located in the first cavity C1, and the third electrode E3 and the fourth electrode E4 may be disposed on the substrate 11 and located in the second cavity C2.

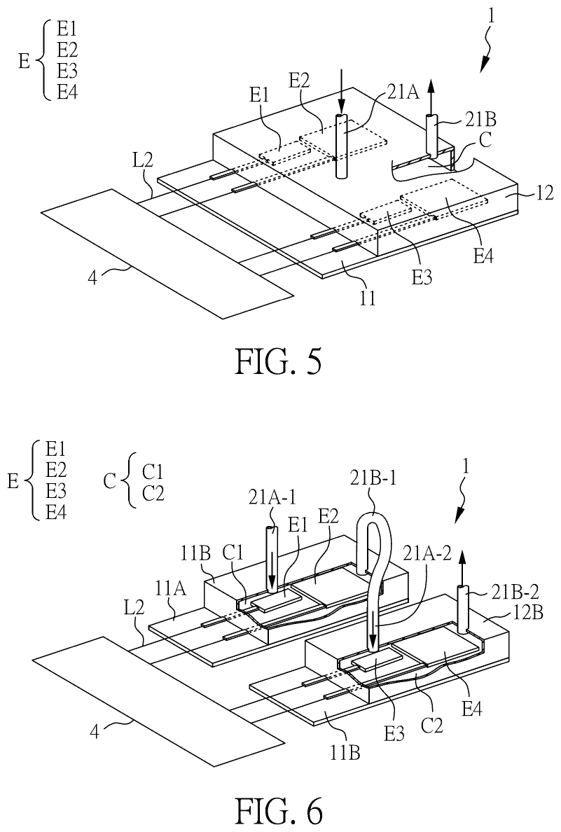

In one embodiment of the present disclosure, as shown in FIG. 5, the detection module 1 may include a cavity C and a detection electrode E disposed in the cavity C. The cavity C may be formed by the substrate 11 and the cover 12. The detection electrode E may, for example, include a first electrode E1, a second electrode E2, a third electrode E3 and a fourth electrode E4, disposed on the substrate 11 and located within the cavity C. A solution may be provided to the cavity C of the detection module 1 via the inlet pipeline 21A for detection and/or processing, and the solution may be discharged from the cavity C via the outlet pipeline 21B.

In one embodiment of the present disclosure, when the first electrode E1 and the third electrode E3 serve as reference electrodes, and the second electrode E2 and the fourth electrode E4 serve as the same working electrodes, the detection device may simultaneously perform repeated detection (multiple detections) on the same solution, thereby saving detection time or improving measurement accuracy by comparing data. In another embodiment of the present disclosure, when the first electrode E1 and the third electrode E3 serve as reference electrodes, and the second electrode E2 and the fourth electrode E4 serve as different working electrodes, the detection device may simultaneously perform detections on different parameters of the same solution, thereby saving detection time.

In one embodiment of the present disclosure, as shown in FIG. 6, one end of the inlet pipeline 21A-1 may be connected to the first cavity C1, and the other end may be connected to the gas pump assembly 22 (shown in FIG. 1 and FIG. 2) and the liquid pump assembly 23 (shown in FIG. 1 and FIG. 2). A solution may be supplied to the first cavity C1 through the inlet pipeline 21A-1 for detection and/or processing, and the solution may be discharged from the first cavity C1 through the outlet pipeline 21B-1. One end of the inlet pipeline 21A-2 may be connected to the second cavity C2, and the other end may be connected to the outlet pipeline 21B-1. The solution discharged from the first cavity C1 may be further supplied to the second cavity C2 through the outlet pipeline 21B-1 and the inlet pipeline 21A-2 for detection and/or processing, and the solution may be discharged from the second cavity C2 through the outlet pipeline 21B-2. In this way, the interference caused by the first electrode E1 and the second electrode E2 to the third electrode E3 and/or the fourth electrode E4 may be reduced, thereby improving the measurement accuracy.

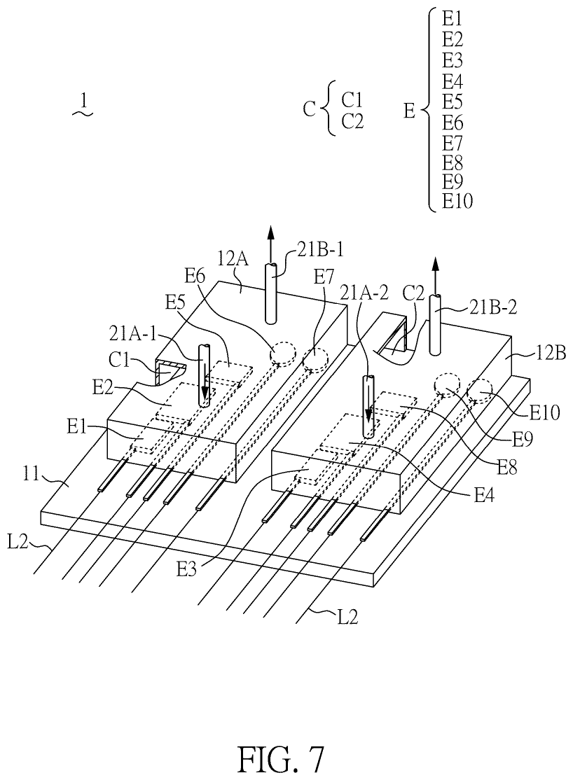

In one embodiment of the present disclosure, the detection module may include multiple electrodes to simultaneously measure multiple parameters of a solution. More specifically, as shown in FIG. 7, the detection electrodes E may include a first electrode E1, a second electrode E2, a third electrode E3, a fourth electrode E4, a fifth electrode E5, a sixth electrode E6, a seventh electrode E7, an eighth electrode E8, a ninth electrode E9 and a tenth electrode E10 disposed on a substrate 11. The first electrode E1, the second electrode E2, the fifth electrode E5, the sixth electrode E6 and the seventh electrode E7 are further disposed in a first cavity C1, and the third electrode E3, the fourth electrode E4, the eighth electrode E8, the ninth electrode E9 and the tenth electrode E10 are further disposed in a second cavity C2.

In the present disclosure, the features of the first electrode E1, the second electrode E2, the third electrode E3 and the fourth electrode E4 may be as described above and will not be repeated here. In the present disclosure, the sizes of the fifth electrode E5, the sixth electrode E6, the seventh electrode E7, the eighth electrode E8, the ninth electrode E9 and the tenth electrode E10 are not particularly limited. For example, in a top view, the projected area of the fifth electrode E5 on the substrate 11 may be greater than, equal to, or smaller than the projected area of the second electrode E2 on the substrate 11, the projected area of the eighth electrode E8 on the substrate 11 may be greater than, equal to, or smaller than the projected area of the fourth electrode E4 on the substrate 11, the projected area of the sixth electrode E6 on the substrate 11 may be greater than, equal to, or smaller than the projected area of the seventh electrode E7 on the substrate 11, and the projected area of the ninth electrode E9 on the substrate 11 may be greater than, equal to, or smaller than the projected area of the tenth electrode E10 on the substrate 11. In one embodiment of the present disclosure, as shown in FIG. 7, the projected area of the fifth electrode E5 on the substrate 11 may be, for example, smaller than the projected area of the second electrode E2 on the substrate 11, the projected area of the eighth electrode E8 on the substrate 11 may be, for example, smaller than the projected area of the fourth electrode E4 on the substrate 11, the projected area of the sixth electrode E6 on the substrate 11 may be, for example, equal to the projected area of the seventh electrode E7 on the substrate 11, and the projected area of the ninth electrode E9 on the substrate 11 may be, for example, equal to the projected area of the tenth electrode E10 on the substrate 11, but the present disclosure is not limited thereto. In the present disclosure, the shapes of the fifth electrode E5, the sixth electrode E6, the seventh electrode E7, the eighth electrode E8, the ninth electrode E9 and the tenth electrode E10 are not particularly limited. For example, the fifth electrode E5, the sixth electrode E6, the seventh electrode E7, the eighth electrode E8, the ninth electrode E9 and the tenth electrode E10 may each be circular, elliptical, rectangular, prismatic, hexagonal, octagonal, or other irregular shapes, but the present disclosure is not limited thereto. In one embodiment of the present disclosure, as shown in FIG. 7, the fifth electrode E5 and the eighth electrode E8 may be rectangular, for example, and the sixth electrode E6 and the seventh electrode E7 as well as the ninth electrode E9 and the tenth electrode E10 may be circular, for example.

In one embodiment of the present disclosure, the first electrode E1 and the third electrode E3 may be, for example, reference electrodes, and the second electrode E2, the fourth electrode E4, the fifth electrode E5, the sixth electrode E6, the seventh electrode E7, the eighth electrode E8, the ninth electrode E9 and the tenth electrode E10 may be, for example, working electrodes for measuring different parameters, but the present disclosure is not limited thereto. In one embodiment of the present disclosure, the first electrode E1 and the third electrode E3 may be, for example, reference electrodes, the second electrode E2 and the fourth electrode E4 may be, for example, pH detection electrodes, the fifth electrode E5 and the eighth electrode E8 may be, for example, electrodes for detecting specific ions (for example, chloride ions, sodium ions, potassium ions, or other suitable ions), the sixth electrode E6 and the seventh electrode E7, and the ninth electrode E9 and the tenth electrode E10 may be, for example, electrodes for measuring other parameters such as conductivity and temperature. When a solution is supplied to the first cavity C1 via the inlet pipeline 21A-1, the pH value, specific ions, conductivity, and/or temperature of the solution may be measured simultaneously or sequentially. When another solution is supplied to the second cavity C2 via the inlet pipeline 21A-2, the pH value, specific ions, conductivity, and/or temperature of the other solution may be measured simultaneously or sequentially, so as to save detection time. In the present disclosure, the solution and the other solution may be the same or different, and may be adjusted according to detection needs.

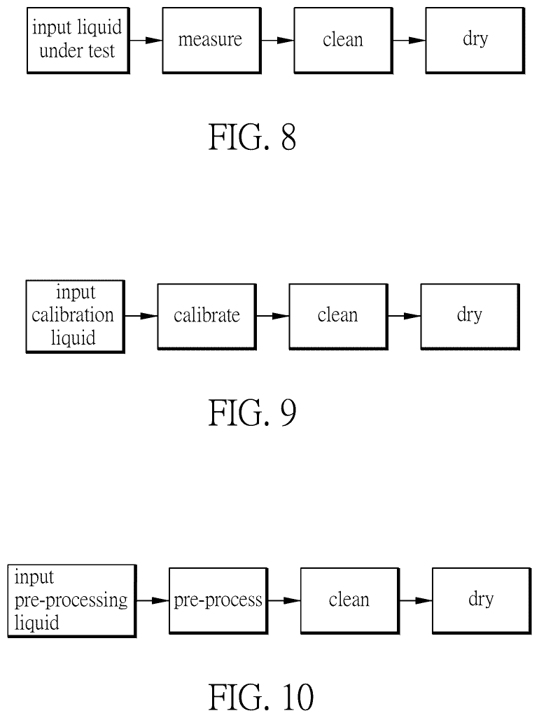

FIG. 8 is a flowchart of a detection method according to an embodiment of the present disclosure. FIG. 9 is a flowchart of a calibration procedure according to an embodiment of the present disclosure. FIG. 10 is a flowchart of a pre-processing procedure according to an embodiment of the present disclosure. The detection device may be as shown in FIG. 1 or FIG. 2, and the detection module 1 may be as shown in any of FIG. 1 to FIG. 7, which will not be described in detail herein.

In one embodiment of the present disclosure, referring to FIG. 1 and FIG. 8, a detection method may include a detection procedure, which includes the following steps: delivering a liquid under test (for example, solution S1) to the detection module 1 through the delivery module 2; detecting (measuring) the liquid under test (for example, solution S1) using the detection module 1; delivering a cleaning liquid (for example, solution S2) to the detection module 1 through the delivery module 2; cleaning the detection module 1 with the cleaning liquid (for example, solution S2); and delivering a gas to the detection module 1 through the delivery module 2, so that the gas dries the detection module 1 and/or the delivery module 2, thereby completing the process of performing a single detection on the liquid under test (for example, solution S1). In the present disclosure, the aforementioned steps may be repeated as needed to perform multiple detections on the liquid under test, or another liquid under test may be delivered to the detection module 1 for another detection. Because the detection method of the present disclosure executes cleaning and drying steps after each detection, the accuracy of the detection device can be improved.

In one embodiment of the present disclosure, as shown in FIG. 1, the detection device may control the delivery module 2 through the control module 3 to provide the liquid under test (for example, solution S1) and/or the cleaning liquid (for example, solution S2) to the detection module 1, thereby realizing automated operation. In the present disclosure, the step of “delivering the cleaning liquid (for example, solution S2) to the detection module 1” refers to, for example, providing the cleaning liquid (for example, solution S2) to the cavity C, but the present disclosure is not limited thereto. The step of “cleaning the detection module 1 with the cleaning liquid (for example, solution S2)” may selectively include allowing the cleaning liquid (for example, solution S2) to remain in the cavity C for 1 second to 60 seconds. In this way, the liquid under test (for example, solution S1) or other substances may be prevented from adhering to and remaining on the surface of the substrate 11, thereby improving the accuracy of the detection. In the present disclosure, the cleaning liquid may be, for example, pure water, deionized water, or other suitable cleaning solutions, but the present disclosure is not limited thereto.

In one embodiment of the present disclosure, the following steps may be included before the step of delivering the liquid under test (for example, solution S1) to the detection module 1: delivering a cleaning liquid (for example, solution S2) to the detection module 1 via the delivery module 2; cleaning the detection module 1 with the cleaning liquid; and delivering a gas to the detection module 1 via the delivery module 2 to dry the detection module 1 and/or the delivery module 2. The additional cleaning of the detection module 1 before performing the detection process may further improve the detection accuracy of the detection device.

In one embodiment of the present disclosure, as shown in FIG. 1 and FIG. 9, before the step of delivering the liquid under test (for example, solution S1) to the detection module 1, a calibration procedure for the detection module 1 may be further included, which includes the following steps: delivering a calibration liquid (for example, solution S3) to the detection module 1 for measurement via the delivery module 2; calibrating the detection module 1 based on the measurement results of the calibration liquid (for example, solution S3); delivering a cleaning liquid (for example, solution S2) to the detection module 1 via the delivery module 2; cleaning the detection module 1 with the cleaning liquid (for example, solution S2); and delivering a gas to the detection module 1 via the delivery module 2, so that the gas dries the detection module 1 and/or the delivery module 2, thereby completing a calibration process for the detection module 1. Since the detection method of the present disclosure performs the cleaning and drying steps after completing the calibration procedure, contamination or influence of the liquid under test may be reduced during subsequent detection, thereby improving the accuracy of the detection device.

In the present disclosure, a calibration procedure may be selectively performed before each detection procedure. For example, a calibration procedure may be performed before each detection procedure, or a calibration procedure may be performed after performing a third number of detection procedures, followed by subsequent detection procedure, wherein the third number is not particularly limited and may be adjusted as needed.

In one embodiment of the present disclosure, the following steps may be included before the step of delivering a calibration solution (for example, solution S3) to the detection module 1: delivering a cleaning solution (for example, solution S2) to the detection module 1 via the delivery module 2; cleaning the detection module 1 with the cleaning solution; and delivering a gas to the detection module 1 via the delivery module 2 to dry the detection module 1 and/or the delivery module 2. The additional cleaning of the detection module 1 before the calibration procedure may further improve the accuracy of the detection device.

In one embodiment of the present disclosure, referring to FIG. 1 and FIG. 10, before the step of delivering the liquid under test (for example, solution S1) to the detection module 1, a pre-processing procedure for the detection module 1 may be further included, which may include the following steps: delivering a pre-processing liquid (not shown) to the detection module 1 through the delivery module 2; pre-processing the detection module 1 with the pre-processing liquid; delivering a cleaning liquid (for example, solution S2) to the detection module 1 through the delivery module 2; cleaning the detection module 1 with the cleaning liquid (for example, solution S2); and delivering a gas to the detection module 1 through the delivery module 2, so that the gas dries the detection module 1 and/or the delivery module 2, thereby completing the process of pre-processing the detection module 1. Since the detection method of the present disclosure performs the cleaning and drying steps before completing the pre-processing procedure, the contamination or influence of the liquid under test may be reduced during subsequent detection, thereby improving the accuracy of the detection device. In the present disclosure, the pre-processing may be a pre-processing liquid dwelling waiting procedure or a power-on measurement procedure, etc., but the present disclosure is not limited thereto.

In one embodiment of the present disclosure, a pre-processing procedure may be performed on the detection module 1 before the calibration procedure is performed; that is, before the calibration solution (for example, solution S3) is delivered to the detection module 1, the pre-processing steps described above may be performed, which will not be described in detail here. Accordingly, the accuracy of the detection device can be improved.

In one embodiment of the present disclosure, the following steps may be included before the step of delivering a pre-processing liquid (not shown) to the detection module 1: delivering a cleaning liquid (for example, solution S2) to the detection module 1 via the delivery module 2; cleaning the detection module 1 with the cleaning liquid; and delivering a gas to the detection module 1 via the delivery module 2, so that the gas dries the detection module 1 and/or the delivery module 2. The additional cleaning of the detection module 1 before the pre-processing procedure may further improve the accuracy of the detection device.

In the present disclosure, a pre-processing procedure may be selectively performed before each detection procedure. For example, the pre-processing procedure may be performed before each detection procedure, or one pre-processing procedure may be performed after performing a fourth number of detection procedures, and then the subsequent detection procedure may be performed. The fourth number is not particularly limited and may be adjusted as needed.

In the present disclosure, the pre-processing solution may include a strong ion solution, such as an acidic solution, a sodium ion-rich solution, a potassium ion-rich solution, or other suitable solution, but the present disclosure is not limited thereto. The required pre-processing solution may be selected depending on the type of detection electrode E. In one embodiment of the present disclosure, the detection method may also directly perform a calibration procedure and/or a detection procedure without a pre-processing procedure.

In one embodiment of the present disclosure, before all the above cleaning steps, another drying step may be selectively performed. For example, in the detection method of FIG. 8, after the liquid under test (such as solution S1) is detected (measured), another drying step may be performed first, and then the cleaning step and the drying step may be performed in sequence. In this way, the cleaning effect can be improved.

With the detection device of the present disclosure including a detection module 1, a delivery module 2 and a control module 3, it is able to achieve an automated detection process. Furthermore, a gas pump assembly 22 is provided in the delivery module 2 to dry any solution remaining in the detection module 1 and/or the delivery module 2, so as to further improve the detection accuracy of the detection device.

1. A detection device, comprising:
a detection module;
a delivery module including:
a delivery pipeline assembly;
a gas pump assembly connected to the detection module via the delivery pipeline assembly; and
a liquid pump assembly connected to the detection module via the delivery pipeline assembly; and
a control module electrically connected to the delivery module for controlling the gas pump assembly and the liquid pump assembly.

2. The detection device as claimed in claim 1, wherein the detection module includes: a cavity; and a detection electrode disposed in the cavity.

3. The detection device as claimed in claim 1, wherein the gas pump assembly includes a first number of gas pumps, the liquid pump assembly includes a second number of liquid pumps, and the second number is greater than the first number.

4. The detection device as claimed in claim 1, wherein a connection between the liquid pump assembly and the delivery pipeline assembly is between a connection between the gas pump assembly and the delivery pipeline assembly and a connection between the detection module and the delivery pipeline assembly.

5. The detection device as claimed in claim 1, wherein a connection between the gas pump assembly and the delivery pipeline assembly is between a connection between the liquid pump assembly and the delivery pipeline assembly and a connection between the detection module and the delivery pipeline assembly.

6. The detection device as claimed in claim 2, wherein the cavity includes a first cavity and a second cavity, the detection electrode includes a first electrode and a second electrode, the first electrode is disposed in the first cavity, and the second electrode is disposed in the second cavity.

7. The detection device as claimed in claim 2, wherein the delivery pipeline assembly includes an inlet pipeline, an outlet pipeline, a first connecting pipeline, and a second connecting pipeline, the inlet pipeline is connected to the cavity of the detection module, the outlet pipeline is connected to the cavity of the detection module, the first connecting pipeline has one end connected to the inlet pipeline and the other end connected to the liquid pump assembly, and the second connecting pipeline has one end connected to the inlet pipeline and the other end connected to the gas pump assembly.

8. The detection device as claimed in claim 7, wherein the delivery module further includes a plurality of check valves respectively disposed between the inlet pipeline and the gas pump assembly and between the inlet pipeline and the liquid pump assembly.

9. The detection device as claimed in claim 1, wherein the delivery module further includes a filter connected to the gas pump assembly.

10. The detection device as claimed in claim 2, wherein the cavity is formed by a substrate and a cover.

11. The detection device as claimed in claim 10, wherein the detection electrode includes a first electrode and a second electrode, the first electrode is a working electrode, and the second electrode is a reference electrode.

12. The detection device as claimed in claim 11, wherein the detection electrode include a first electrode, a second electrode, a third electrode and a fourth electrode, the first electrode and the third electrode are working electrodes, and the second electrode and the fourth electrode are reference electrodes.

13. The detection device as claimed in claim 6, wherein the first cavity is formed by a first substrate and a first cover, and the second cavity is formed by a second substrate and a second cover.

14. The detection device as claimed in claim 13, wherein the detection electrode further includes a third electrode disposed in the first cavity and a fourth electrode disposed in the second cavity, the first electrode and the third electrode are disposed on the first substrate, the second electrode and the fourth electrode are disposed on the second substrate, the first electrode and the second electrode are working electrodes, and the third electrode and the fourth electrode are reference electrodes.

15. The detection device as claimed in claim 6, wherein the first cavity is formed by a substrate and a first cover, and the second cavity is formed by the substrate and a second cover.

16. The detection device as claimed in claim 15, wherein the detection electrode further includes a third electrode disposed in the first cavity and a fourth electrode disposed in the second cavity, the first electrode, the second electrode, the third electrode, and the fourth electrode are disposed on the substrate, the first electrode and the second electrode are working electrodes, and the third electrode and the fourth electrode are reference electrodes.

17. A detection method for a detection device including a detection module, a control module, and a delivery module connected to the detection module, the detection method comprising the steps of:
delivering a liquid under test to the detection module through the delivery module;
detecting the liquid under test with the detection module;
delivering a cleaning liquid to the detection module through the delivery module;
performing a first cleaning on the detection module with the cleaning liquid; and
delivering a gas to the detection module through the delivery module, so that the gas dries the detection module.

18. The detection method as claimed in claim 17, further comprising, before the step of delivering the liquid under test to the detection module, the steps of:
delivering a calibration liquid to the detection module through the delivery module for measurement; and
calibrating the detection module using a measurement result of the calibration liquid.

19. The detection method as claimed in claim 17, further comprising, before the step of delivering the liquid under test to the detection module, the steps of:
delivering a pre-processing liquid to the detection module through the delivery module; and
performing a pre-processing on the detection module with the pre-processing liquid.

20. The detection method as claimed in claim 17, further comprising, before the step of delivering the liquid under test to the detection module, the steps of:
delivering a cleaning liquid to the detection module through the delivery module; and
performing a second cleaning on the detection module with the cleaning liquid.
